(19) United States
(12) Patent Application Publication
(10) Pub. No.: US 2016/0224637 A1
(43) Pub. Date: Aug. 4, 2016

(54) PROCESSING ASSOCIATIONS IN KNOWLEDGE GRAPHS

(71) Applicant: UT Battelle, LLC, Oak Ridge, TN (US)

(72) Inventors: Sreenivas R. Sukumar, Oak Ridge, TN (US); Larry W. Roberts, Oak Ridge, TN (US)

(73) Assignee: UT Battelle, LLC

(21) Appl. No.: 15/004,402

(22) Filed: Jan. 22, 2016

Related U.S. Application Data
(63) Continuation-in-part of application No. 14/089,395, filed on Nov. 25, 2013.
(60) Provisional application No. 62/106,342, filed on Jan. 22, 2015.

(51) Int. Cl. G06F 17/30

(52) U.S. Cl. CPC G06F 17/30539; G06F 17/30864

(57) ABSTRACT

A data infrastructure for graph-based computing that combines the natural language expressiveness of the Semantic Web and the mathematical rigor of graph theory to discover meaningful associations across multiple sources towards computer-assisted serendipitous insight discovery. The process automatically integrates massive size datasets accessed using Semantic Web standards and technologies and normalizes data in graphs. The process generates a plurality of conditional probability distributions based on type-triple meta-data and triple statistics to model saliency and automatically construct and evaluate a plurality of sub-graphs based on the plurality of conditional probabilities for contextual-saliency. The process then renders a plurality of paths (i.e. sequence of associations) that model meaningful pairwise relations between objects of the normalized integrated data. The pluralities of conditional probabilities reveal and rank previously unknown associations between entities of user-interest in the knowledge graph.

### RELATED APPLICATION

This application claims the benefit of priority of U.S. Provisional Pat. App. No. 62/106,342 filed Jan. 22, 2015 and titled “Scalable Pattern Search in Multi-Structure Data,” and is a continuation-in-part of U.S. patent application Ser. No. 14/089,395 filed Nov. 25, 2013 and titled “Knowledge Catalysts,” both of which are incorporated by reference.

### STATEMENT REGARDING FEDERALLY SPONSORED RESEARCH AND DEVELOPMENT

This invention was made with United States government support under Contract No. DE-AC05-00OR22725 awarded by the United States Department of Energy. The United States government has certain rights in the invention.

### BACKGROUND

1. Technical Field

This disclosure relates to systems and processes that gather information from multiple heterogeneous machine-readable sources into knowledge graphs to reveal and rank associations between entities with semantic (natural language) context and meaning.

2. Related Art

The Word Wide Web (WWW) is designed for human use. It interconnects documents, files, and sites that are often identified through databases that are searched by keywords. Information seekers typically enter search parameters that return results in the form of interlinked documents. Often the documents do not illustrate information about the relationships between them or the relationships of the documents to the keywords. This state of the art makes navigating and searching the WWW difficult and pushes the problem of searching to the user. Making the problem worse, information generated by keyword-based searches often return results that are not relevant or reliable. Furthermore, the ability to evaluate the strength of meaningful association between two keywords has not been investigated well.

To address this problem, the Semantic Web was created. The Semantic Web is an extension of the legacy Web in which information is given more meaning. Its aim is to develop the Web into a distributed global system of knowledge representation and computing that enables users and computers to understand the meaning of information. The system is based on ontologies and globally unique identifiers that are served by common data formats. The ontologies provide the vocabulary and the semantics of the annotations. They provide the logical pieces of meaning that can be manipulated by a Resource Description Framework (RDF). The RDF model is a logical data model that describes Web resources and their interrelations. The statements are generally in the form of subject-predicate-object expressions that are known as triples.

While the design and coding methods of the Semantic Web promotes and enhances common data formats, it is not suited to model, derive pairwise relations or mine insightful meaning between Web based objects. The state of the art lacks solutions that work with knowledge graphs that scale to the level of resources available across the Web. The solution provided in this disclosure is a new capability that addresses this deficiency by minimizing the latency and complexity that occurs when executing interactive intuitive and instinctive machine reasoning—even on much smaller data sets.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is an exemplary predicate-subject count query process.

FIG. 2 is an exemplary predicate-object count query process.

FIG. 3 is an exemplary process that determines the average counts of the predicate-subject.

FIG. 4 is an exemplary process that determines the average counts of the predicate-object.

FIG. 5 is an exemplary heterogeneous paths query.

FIG. 6 is a specific reasoning example query.

FIG. 7 is an exemplary pattern similarity query.

FIGS. 8 (a and b) are exemplary selected triple queries.

FIGS. 9 (a and b) are exemplary path application queries.

FIG. 10 is an exemplary context term query.

FIGS. 11 (a and b) shows exemplary paths by predicate weight queries.

FIG. 12 is a framework of semantic associations.

FIG. 13 represents the data space for mining the associations and the required data space required to extract class association rules.

FIG. 14 is an example decision RDF store in a shared memory architecture.

FIG. 15 shows three cases with support for a rule.

FIG. 16 shows five cases with a constant confidence for rule X-->Y.

FIG. 17 is a set of factor-sets with their support count.

FIG. 18 is a set of class association rules with interestingness measures.

FIG. 19 show exemplary paths scored by an expert system.

### DETAILED DESCRIPTION OF THE PREFERRED EMBODIMENTS

This disclosure describes systems and processes (referred to as system(s)) that combine graph-theoretic methods with automatic data integration of big data through the Semantic Web. The systems identify the state of the art in the physical, biological, social, and information domains. This means that the systems can accelerate discovery in areas as diverse as personalized healthcare, cyber security, counterterrorism, drug discovery and development, fraud and risk analysis, marketing, law enforcement, etc. The systems identify hidden and non-obvious connections in big data that can lie in common or disparate remote domains and deliver results quickly and simply by building a schema free graph relationship warehouse that supports inferences, deductions, pattern-based queries, and intuitive visualizations rendered via displays. The systems identify and create relationships dynamically as data sources are added by incrementally fusing structured, semi-structured, and un-structured data with legacy data sets without executing upfront modeling.

Because some disclosed systems support collaboration between users and iterative searches, these systems include hardware accelerators and application programming interfaces that leverage multi-thread processing technology. Instead of optimizing data models for specific questions, the systems support discovery through iterative real-time processes where results of a user's first query determines the next query that is rendered automatically and is transmitted automatically or manually. These systems and the others described herein are implemented with a scalable-shared (or distributed) memory architecture that is accessible to remote clients. The scalable-shared memory architecture includes an optimized software stack for graph pattern searching of knowledge graphs. The architecture enables processing the association/relationships both deep-and-wide with interactive real-time latency response on queries. The systems transform state of the art devices that access software stacks into open architecture reasoning devices that execute novel algorithms and interfaces that allow users to navigate/explore knowledge graphs semantically, statistically, and logically.

The highly scalable system includes input/output (I/O) devices that integrates and normalizes the datasets that render knowledge graphs and with the ability to learn signal from noise (noise defined as content out of context during search) through data normalization procedures. The I/O is programmed to extract statistically significant and useful knowledge from data sets that may take the form of vectors, tables, images, etc. The term “graph” in this disclosure refers to a directed labeled multi-graph in computer graph theory with possible loop edges that represent a set of triples; the two representations are used interchangeably.

To identify content within context and relevance after integrating structured and/or unstructured data sets, an I/O filter evaluates subgraph patterns/probabilities from data sets. The data subgraphs are then processed by one or more applications. The applications include one or more term-reasoning applications, pattern-similarity applications, explore-triple applications, path-based reasoning applications, context-reasoning applications, path-ranking applications, and meta-pattern reasoning applications. The term reasoning application renders an interface in which a user or device may manually or automatically provide a specific term(s) in the search for a collection of similar terms. The workflow constructed using these applications can be used to find terms that are similar to a user specified term or evaluate the association between multiple user-specified terms. Each application applies different rules on what it means for two terms to be similar under different context heuristics.

To minimize and/or eliminate noise the signal subgraphs are selected based on scores and threshold comparisons from the aforementioned applications. When the score of a triple is below a predetermined processed threshold, the triple is classified as noise and thereby labeled with a saliency score of lower priority while processing associations. In this disclosure, the score for triple importance/relevance is defined by the number of times the subject-predicate appears in the integrated knowledge graph multiplied by the number of times the predicate-object appears in the same graph. More formally, if

scoreₛₚ(sub,pred)|{(sub,pred,o):(sub,pred,o)εG}|

and

scoreₚₒ(pred,obj)=|{(s,pred,obj):(s,pred,obj)εG}|

then,

score(sub,pred,obj)=scoreₛₚ(sub,pred)·scoreₚₒ(pred,obj).

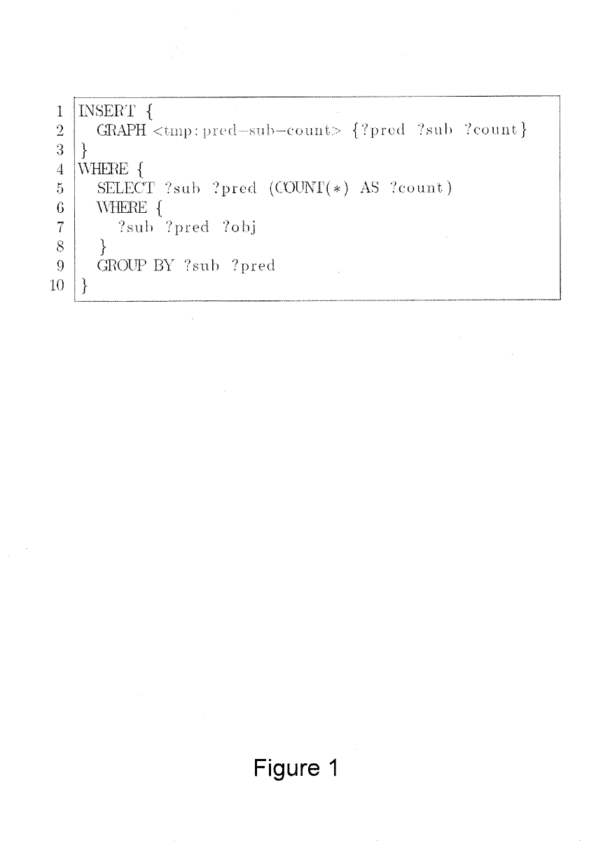

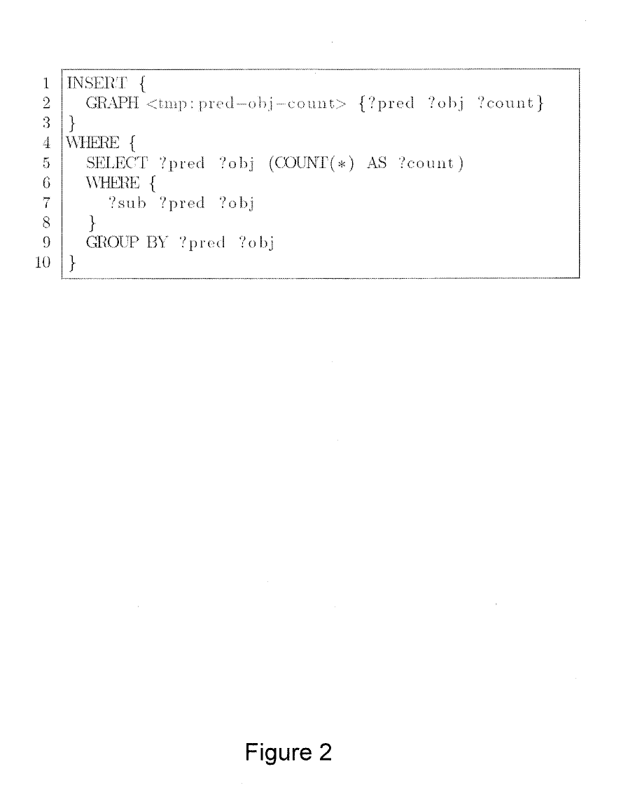

The query processes calculate the value of scoreₛₚ and scoreₚₒ for every subject-predicate and predicate-object pair in the graph as shown in FIGS. 1 and 2, respectively. The threshold for the triple is defined by the average of the subject-predicate pair counts multiplied by the average of the predicate-object pair counts, where the predicate is given in the triple and the subject and object range over all possible subjects and objects in the graph. More specifically, if PS={(sub,pred):(sub,pred,o)εG}, PO={(pred,obj):(s,pred,obj)εG},

and if

$${threshold}_{sp} ( pred ) = \frac{{\sum }_{( sub , pred ) ∈ {P}_{S}}^{ } score ( sub , pred )}{\vert {P}_{S} \vert}$$

and

$${threshold}_{po} ( pred ) = \frac{{\sum }_{( pred , obj ) ∈ {P}_{O}}^{ } score ( pred , obj )}{\vert {P}_{O} \vert} ,$$

then the threshold is given by

threshold(pred)=thresholdₛₚ(pred)·thresholdₚₒ(pred).

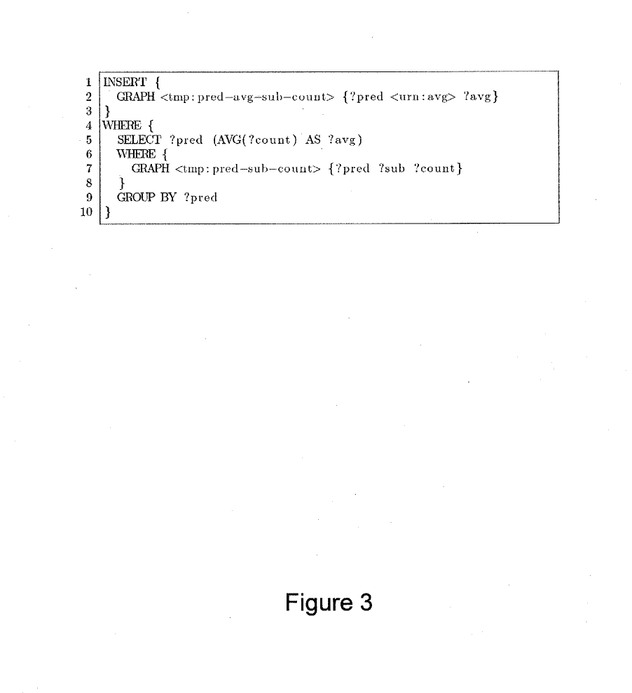

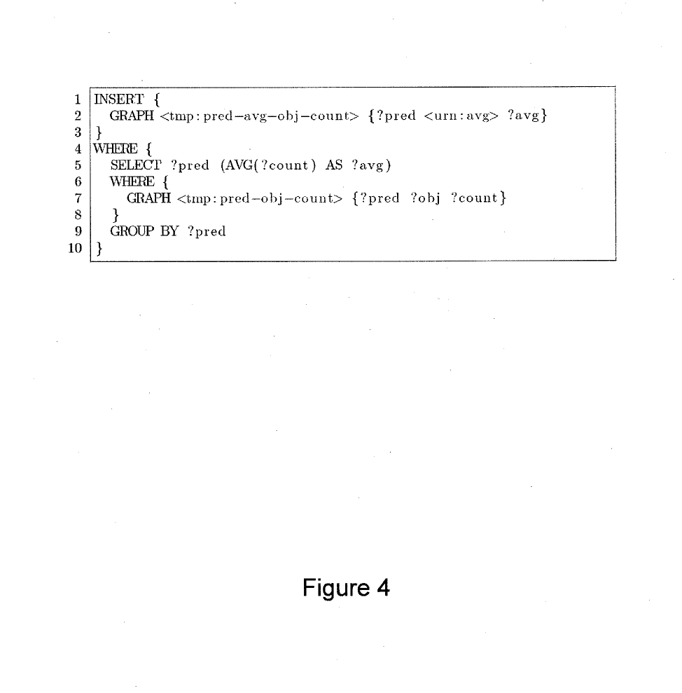

The processes of FIGS. 3 and 4, respectively, calculate the value of thresholdₛₚ and thresholdₚₒ for the predicates in the graph. The heterogeneous paths graph G is determined by the collection of all triples in graph G such that the score of the triple is greater than or equal to the threshold of the triple. That is,

G′={(sub,pred,obj)εG:score(sub,pred,obj)≧threshold(sub,prod,obj)}

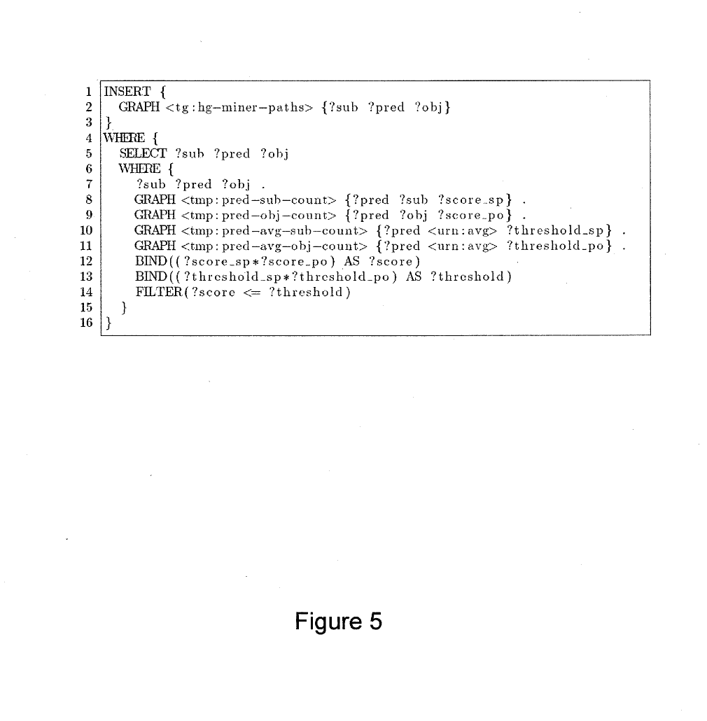

And, thus the process shown in FIG. 5 filters and automatically ranks and separates salient triples from the irrelevant triples in the integrated knowledge graph.

The system analytics apply computer graph theory to the filtered semantic data sets without executing (minimizing/eliminating) matrix operations. Graph theory analyzes graphs, which are mathematical structures used to model pairwise relations. The system analytics applies graph-theoretic functionality at WWW scale to semantic objects and semantic relationships—beyond pairwise analysis. The systems mine large sets of RDF triples that can be stored in the globally shared memory architectures through SPARQL. The disclosed globally shared memory architectures enables low latency access to the filtered semantic data because the novel architecture need not consider memory partitions, memory layout, data locality problems, and access patterns, which eliminates the delays associated with network access and fast retrieval. A semantic reasoning library, a statistical reasoning library, and a logical reasoning application are executed by the processor to uncover unknown or overlooked data connections that can identify new areas of research. This is called computer rendered serendipity in this disclosure.

Any of the aforementioned reasoning application recognizes that two terms are similar (or associated) if they share similar neighborhoods in a graph—i.e., they have similar local, multi-scale and global graph-theoretic properties. For example, given a term of interest, the size of the overlap (intersection) between the neighbors of the term(s) of interest and the neighborhoods of every other term in the graph is calculated. The top “n” terms with the largest overlap are returned to the user as the most similar terms.

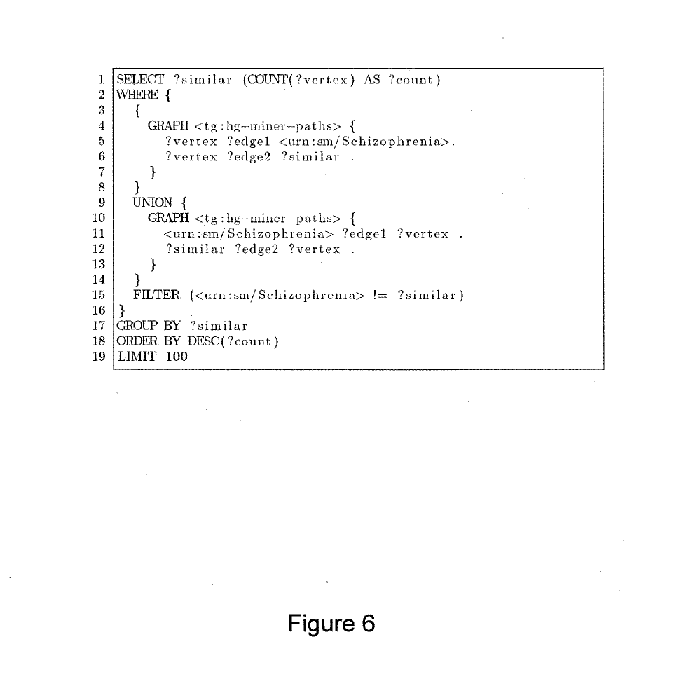

More specifically, let G=(V,E,φV,φE,L) be a graph and let NG+(v)={u:(v,u)εE}, NG−(v)={u:(u,v)εE}, and NG(v)=NG+(v)∪NG−(v) denotes the (open) out-neighborhood, (open) in-neighborhood, and (open) neighborhood of a vertex v in V, respectively. Then, the similarity between two vertices “v” and “u” is defined as |NG (v)∩NG (u)|. Note that the labels of the edges connecting a term to its neighbors are ignored when considering the neighborhood. The specific reasoning application can process the entire graph or the subgraphs prioritized based on the saliency score labels. FIG. 6 shows an exemplary query that renders similar terms to the term “schizophrenia”—in this case leveraging local-context graph heuristic on high-saliency score terms in the knowledge graph.

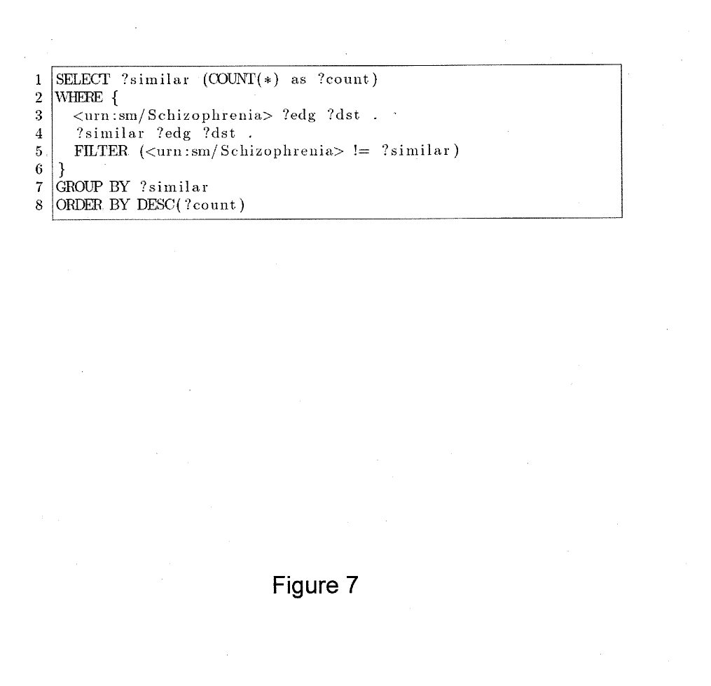

Much like specific reasoning application, the pattern similarity application recognizes two terms as similar if they have similar out-neighborhoods in a graph. Unlike specific reasoning, the value of the predicate is recognized as important when measuring similarity. If graph G is recognized as a collection of subject-predicate-object triples, then the similarity between two vertices v and u is defined as |{(p,s):(v,p,s)εG}∩{(p,s):(u,p,s)εG}|. An exemplary query returning terms similar to the term “schizophrenia” by the pattern similarity algorithm is shown in FIG. 7.

Given a desired term of interest, the explore triples application retrieves a ranked-list of all the subject-predicate-object associations from the integrated knowledge graph (particularly retrieving triples that formed during data integration). The explore triples application automatically identifies two terms as related when the terms are close to each other in the graph (i.e., semantically meaningful entity-relationship meta-paths exist between the terms). Specifically, the explore triples application returns a collection of “n” hop paths (i.e, sequence of connected triples) from the specified term. A score is calculated for each exploratory path by taking the reciprocal of the saliency score of each subject-predicate-object triple represented in the path. For example, let p=(v₀, e₀, v₁, e₁, . . . , eₙ₋₁, vₙ) be an arbitrary “n” hop path. Then, the score of path “p” is given by

$$\frac{{\sum }_{i = 0}^{n - 1} {score ( {v}_{i} , {e}_{i} , {v}_{i + 1} )}^{- 1}}{n} .$$

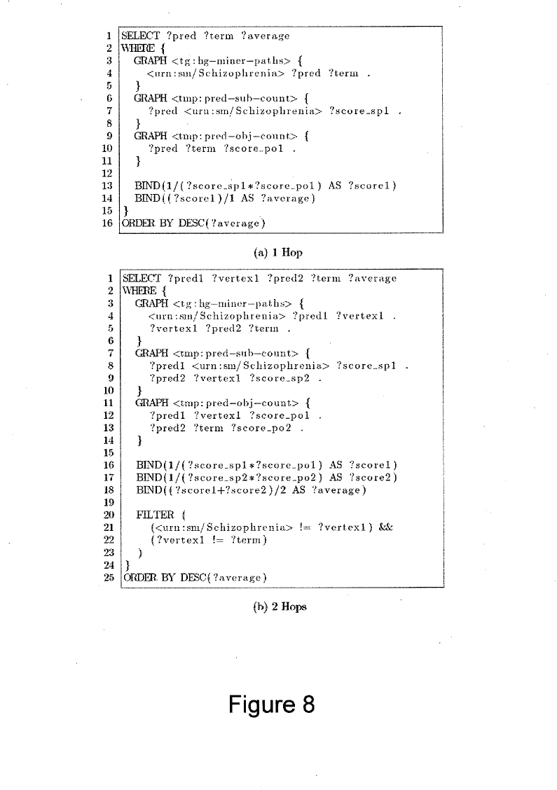

Note that each (vᵢ,eᵢ,vᵢ₊ᵢ) for 0≦i<n is a triple in the graph. These scores, are then processed to order the paths from highest to lowest score. FIGS. 8a and 8b show exemplary processes used to obtain terms similar to the term “schizophrenia” that are one and two hops away, respectively.

Given a pair of terms, the system can also recognize common concepts associated with the two input terms, and uncover relationships between the terms. The collection of applications under path reasoning application can find these common terms and hidden relationships. The different applications are each based on different notions of the commonality between terms.

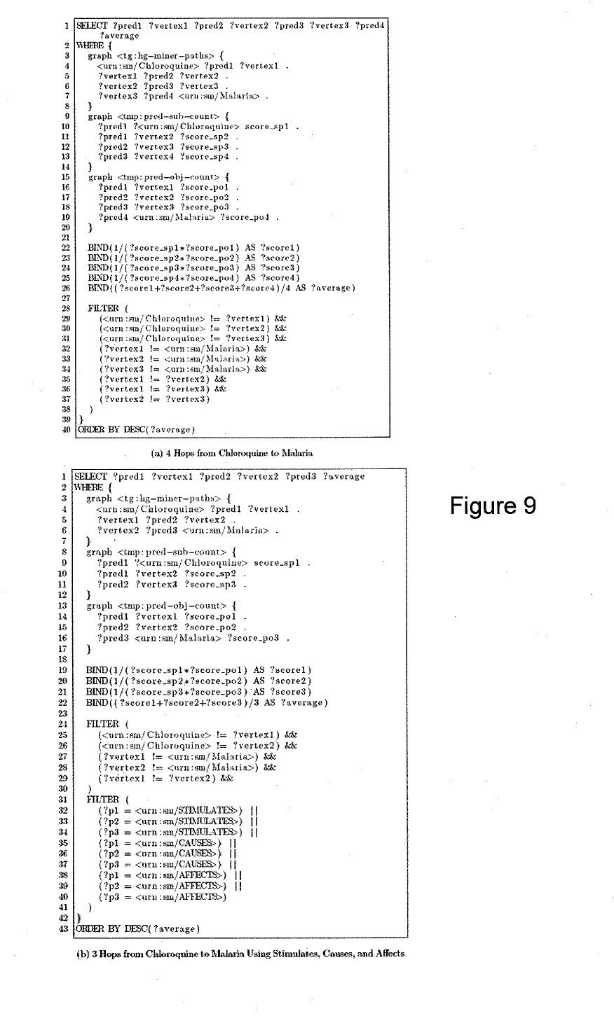

The path-reasoning application returns a collection of paths between a specified start and end term in the graph. The paths applications allow the number of hops to be specified; such as within a range of two hops for example. An optional list of predicates, if provided, will filter for paths whose edge labels are in the list of desired predicates. Paths are ordered using the same strategy as the browse triples applications. The query used by the paths application to find a four hop path starting at “chloroquine” and ending at “malaria” is shown in FIG. 9a. The query to obtain 3 hop paths between the terms “chloroquine” and “malaria” using only the predicates “stimulates, “causes, and affects” is shown in FIG. 9b.

The context terms application finds common terms between two specified terms. The application finds the overlap between the one and two hops neighbors of the specified terms in the graph. More formally, “u” and “v” are vertices in a graph G. If

$$V = ( {⋃}_{{v}^{′} ∈ {N}_{G}^{+} ( v )} {N}_{G}^{+} ( {v}^{′} ) ) ⋃ {N}_{G}^{+} ( v )$$

$$U = ( {⋃}_{{u}^{′} ∈ {N}_{G}^{+} ( u )} {N}_{G}^{+} ( {u}^{′} ) ) ⋃ {N}_{G}^{+} ( u )$$

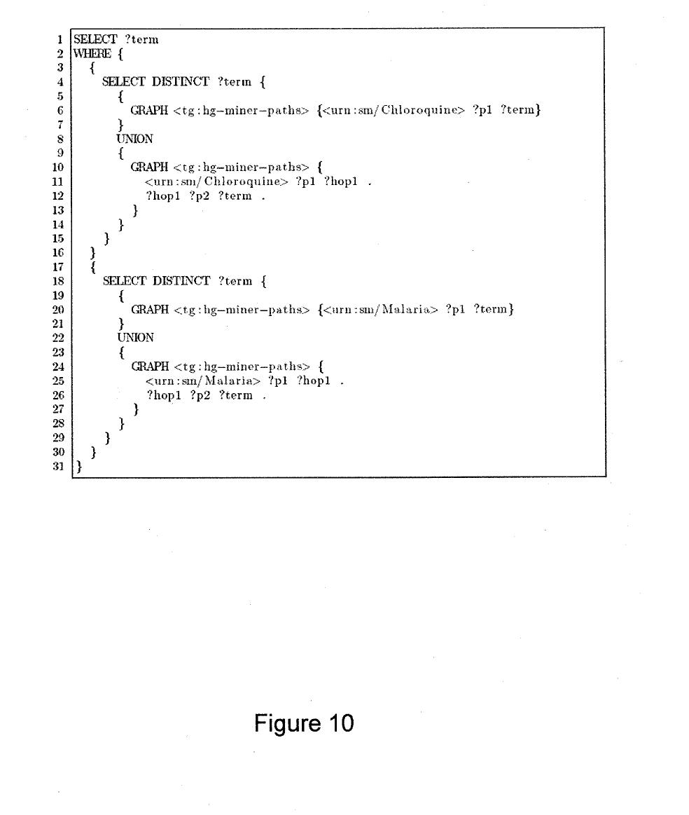

are the collection of one and two hop neighbors of “v” and “u”, respectively, then the terms returned by the context terms algorithm are precisely the terms represented by the vertices in V∩U. The query used to obtain common terms between the terms “chloroquine” and “malaria” is shown in FIG. 10.

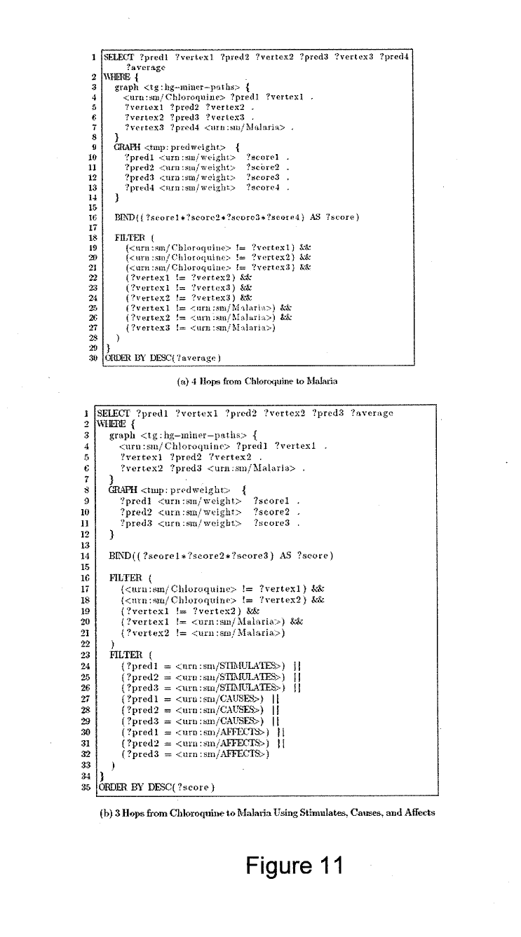

The path-ranking application execute like the paths application, but process legacy domain knowledge or domain knowledge provided by a user. Specifically, every predicate is given a weight that represents its utility, where higher weights identify more useful predicates. The utility weights can vary from domain to domain and user to user. These weighted values are stored in memory in a named graph for use when querying. The score of each path is defined to be the product of the weights of the predicates used in the path. The query to obtain 4 hop paths between “chloroquine” and “malaria” is shown in FIG. 11a, while the query to obtain 3 hop paths between “chloroquine” and “malaria” using only the predicates “stimulates, causes, and affects” is shown in FIG. 11b.

The meta-pattern reasoning application uncovers previously overlooked relationships by searching for paths in a graph based on an underlying discrete probability distribution. It helps users to design a meta-pattern of interest and retrieves entity-relationships that satisfy the meta-patterns. Since every subject-predicate-object triple in the graph is a distinct entity-entity relationship, the entity-type information (meta-data about entities—terms and relationships) is incorporated to construct and render a meaningful probability distribution as the search heuristic. Towards that goal, a type-triple probability distribution is constructed. A type-triple is a triple of the form (st,p,ot), where “st” (subject-type) and “ot” (object-type) are term-types and “p” is a predicate. Then, the conditional probability that a type-triple has predicate “p” and object-type “ot” given a subject-type of “st” are calculated. Given a partial type-triple of the from (sub,p,ot), where “sub” is a subject but “ot” is a term-type, the process calculates the probability of “p” and “ot” given sub. The meta-pattern reasoning application recognizes the use of these conditional probabilities when constructing paths, which may be pre-computed and stored in memory as a static file.

The meta-pattern reasoning application begins by specifying a starting-type or a term, and returns a collection of “m” paths, each with “n” hops. Each of the m paths is constructed as follows. Given a starting-type, the first type-triple (hop) is selected following the conditional probability distribution where the subject-type is given as the starting-type. Given a starting term (subject), the first type-triple is selected when the subject-type matches the starting term and the predicate and object-type follow the conditional probability distribution. Subsequent type-triples (hops) are selected from the conditional probability distribution where the subject-type is given to be the previous type-triple's object-type.

Given a pair of terms, the analogy-based reasoning application finds other pairs of terms that are analogous to the given pair of terms. While the analogy-based reasoning application uncovers direct patterns in the semantic data, it also identifies pairs of terms that are not directly related, but are analogous to a given pair of terms that are directly related. For example, a user may provide an “analogy—example” for a drug—symptom pair of terms such as “Nexium” and “Heartburn”. The analogy-based reasoning application calculates the probability distributions of “m” paths, for “n=1, 2, 3, . . . , n” hops between the “analogy-example” terms. This probability distribution is then used to evaluate the strength of association on exploratory searches such as “chloroquine” and “Ebola_virus”.

The analogy-based reasoning application is defined by letting “Pₙ” be any collection of paths of length “n” in a graph. For every 1≦i≦n+1, there is a discrete probability distribution that gives the probability the ith vertex in a path from “Pₙ” has a given term-type. Similarly, there is a discrete conditional probability distribution that gives the conditional probability the ith vertex in a path from “Pₙ” given the previous i−1 term-types. These probabilities are used to both construct probabilistic meta-patterns of subgraphs for the query term-pair for interactive exploration and to evaluate the score of similarity to a user-specified analogy.

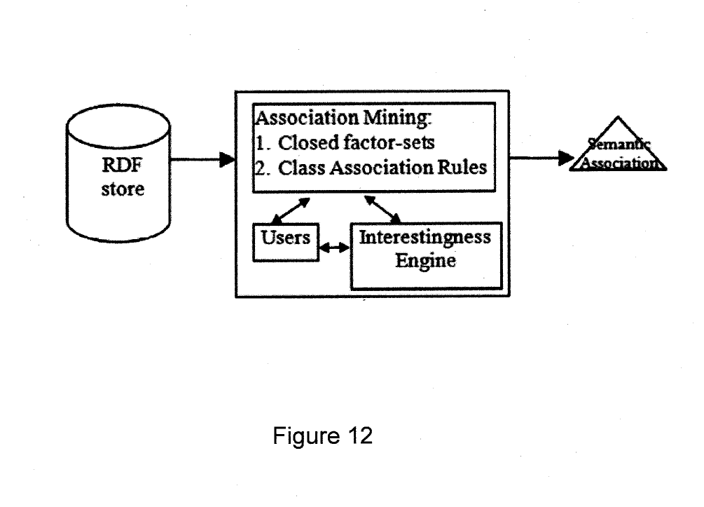

The statistical reasoning library searches for associations and integrates pattern assessment elements within the system by guaranteeing statistical significance and validity—i.e. provides proof and support with confidence that an association is not random. Frequent closed itemsets, and additional interestingness criteria are used to select patterns and mine as shown in FIG. 12. The class association rules shown in FIG. 12 are a subset of association rules whose consequences are restricted to predefined target labels. This makes mining associations more applicable and practical in web-scale data. Like frequent closed itemsets in the association rule mining, closed factor-sets are used to generate class association rules. Beside support and confidence, other measures filter out trivial patterns.

In the statistical reasoning library an information system is used for representing knowledge U={E∪R∪L}, where “E” is an entity, “R” is a relationship, and “L” is a literal. An entity is any tangible and intangible object in the world, such as a composer, an author, a song, a drug, a symptom or a novel.

A relationship is an association between entities. A literal is any value of an entity. for example—“Nexium treats Heartburn”, Nexium is a drug entity and Heartburn is a symptom entity and ‘treats’ is the relationship between drug and symptom. Within the RDF data model, information is expressed as a set of binary propositions and is represented by facts denoted as triples consisting of a subject, a predicate, and an object. A RDF triple “s” is represented as sε{E,R,(E∪L)}. Its first component (the subject) stands in the relation given by the second component (the predicate) with the third component (the object), as in {composer, writes, song} and {author, writes, novel}. The terms used in a RDF triple are relative URLs in a pair of angle brackets and literals in a pair of quotation marks. Literals are typed data values that can be used, and located at the object position. Each triple establishes a link between the entity recognized by the subject with the entity identified by the object via the predicate.

Association rules are applicable in the analysis of RDF stores shown in FIG. 12, as every edge of the graph has a unique combination of vertex and edge labels. Analogous to traditional transaction data, the subject “s” of a triple tuple can be considered as a “transaction ID” and the combination of its corresponding predicate “p” and object “o” can be seen as an “attribute-value” pair. Like an item, each pair of predicate “p” and its corresponding object “o” are designated a Factor, i.e., f={p o}. Let F={fᵢ|i=1, n} in a set of distinct factors in the dataset. Any set of factors in “F” is called a factor-set. With these virtual mappings, the statistical reasoning algorithm treats a RDF store “U” as a collection of m data cases, U={cᵢ|i=1, . . . , m}. Each case “cᵢ” has a unique subject ID (sid) and contains a subset of factors in F, i.e., cᵢ={sidᵢ, |j=1, . . . , q}. Here a RDF store refers to any information system U={C,P}, where:

“C” is a nonempty and finite set of cases

p:U→Oₚ is a function for any pεP where Oₚ is designated the domain of “p”.

Elements of “U” are designated cases. When applied to medicine, for example, the cases can be interpreted as patients. Properties “P” are interpreted as attributes such as diagnosis made by a doctor, characteristic of a tumor status, etc. And, the pair of property-value is called a Factor.

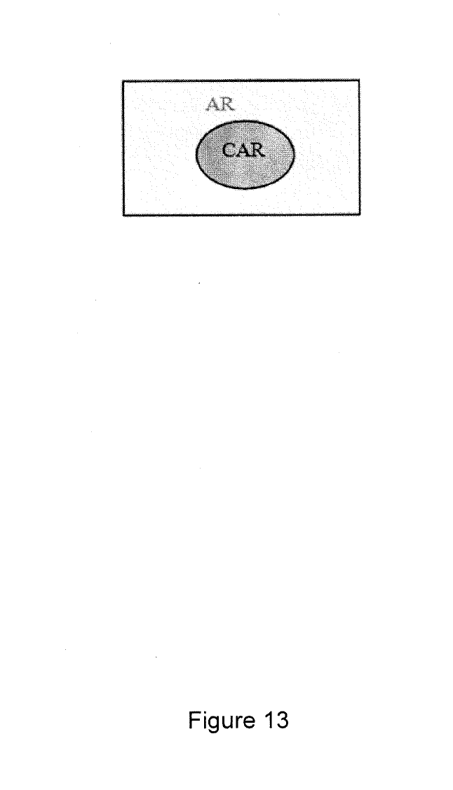

A pattern “X” is a subset of a case, X⊂U. A pattern with “k” factors is called k-pattern. The support of a pattern “X” is the ratio of the number of cases containing “X” to the number of all cases in “D”, denoted by sup(X). An association rule is an implication of the form X-->Y, where X≠Ø, X⊂F, Y⊂F, X∩Y=Ø. “X” is called the antecedent and Y is called the consequent of the rule. XY is a frequent factor-set. Strong association rules are derived from frequent factors. The support of the rule is as sup(X∪Y) and the confidence of the rule is defined as conf(X→Y)=sup(X∪Y)/sup(X). In FIG. 13 the rectangle box represents the entire data space for mining association rules (AR) and the circle indicates the required data space to extract Class Association Rules (CAR) without information loss.

Instead of searching the entire data space for every possible association rule, the applications in the statistical reasoning library find relevant materials from the Web by restricting the search to the user's preference. Adding a constraint to limit the factors that can appear on the consequence of the rule that is known as a class association rule. Only a small portion of data space is required for defining such rules, which reduces computation complexity and minimizes the number of trivial rules.

To mine class association rules, the statistical reasoning application analyzes information systems called decision tables. A decision table comprises a set of cases where each case is described by a set of properties. Properties are partitioned into a premise and a target. For a medical dataset, for example, the “diagnosis” may be the target attribute. Its domain is defined as a set of literals. The target attribute classifies cases with respect to the diagnosis by a physician at a hospital, for example.

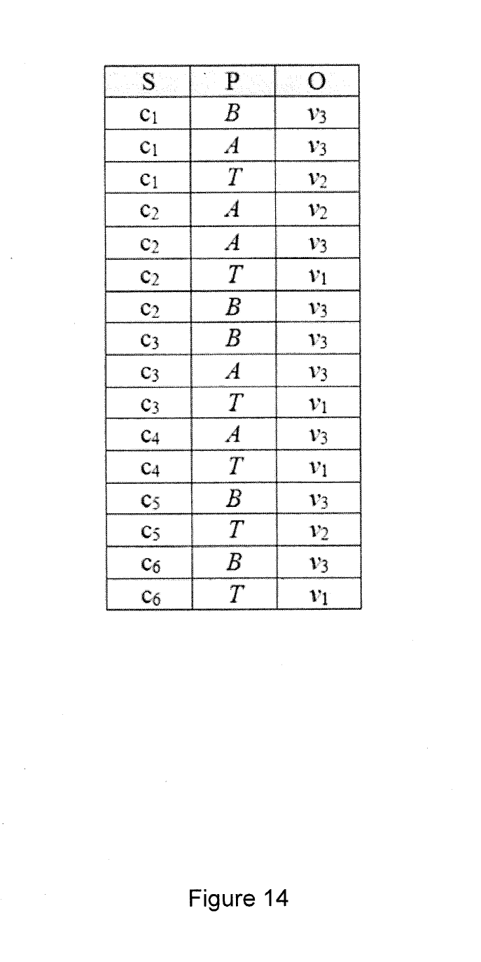

If U={C,P} is an information system and if there exists Pc, Pₜ⊂P, such that Pc∩Pₜ=Ø and Pc∪Pₜ=P, then U is a decision table. A decision table is denoted as U={C,Pc∪Pt}, where “C” is a nonempty and finite set of cases, “Pt” is a distinguished property called a target class, and “Pc” is called premise properties. The set of factors “F” in “U” can be partitioned into premise factors “Fc” and target factors “Ft”. “Ft” is a targeted predicate “pt” with a set of its associated distinct object values, Ft={pt, |j=1, . . . , q}. Assume that U {(c₁, c₂, c₃, c₄, c₅),(A,B)∪(T)} is a decision table represented by the table shown in FIG. 14. It comprises 6 cases {c1, c2, c3, c4, c5, c6}. The predicates in {A,B} are premise one and predicate T is the target predicate and minimum support sup(r) is about 15%.

A decision system “U” that uses a table such as the table shown in FIG. 14 classifies a set of cases so that for each object there exists a class label assigned to it. A class association rule “r” in “U” can be expressed as: r=X→Y, where X≠Ø, X⊂F_{c}, YεFₜ, and X∩Y=Ø. The antecedent “X” of the rule is a set of premise factors and the consequent “Y” is the target used to characterize interesting segments of the populations and must be specified by a user. A closed factor-set “f” in “U” means a term f=[(p₁,o₁) [symbol] (p₂,o₂) [symbol] . . . [symbol] (pₗ,oₗ)] if an only if none of its supersets f′ satisfies sup(f)=sup(f′). This means that “f” is not closed if at least one of its immediate supersets has the same supports as “f”. Referring to FIG. 14, the factor-set [(A,v3),(T,v1))] has support count 3. Notice that the support count of [(A,v3), (B,v3), (T,v1))] is 2, so both of them are closed factor-sets. Otherwise, only [(A,v3), (B,v3), (T,v1))] is a closed factor-set.

By a frequent closed factor-sets ξ, we mean that ξ=[(p₁,o₁) [symbol] (p₂,o₂) [symbol] . . . [symbol] (pₗ,oₗ)] is a frequent closed factor-set if ξ is a closed factor-set and sup(ξ)≧λ₁. Referring to FIG. 14, the predefined thresholds for support is 15%, [(A,v3), (B,v3), (T,v1))] is a frequent closed factor-set because its support is about 25%.

Interestingness measures play an important role in establishing pruning strategies to improve the efficiency of the statistical reasoning application, but also for ranking and evaluating the value of the mined patterns. Criteria for determining whether a pattern is interesting are: generality, reliability, conciseness, peculiarity, surprisingness, diversity, novelty, utility, and action-ability. Probability-based measures have been successfully used to gauge the generality and reliability of association rules. The conciseness, peculiarity, and surprisingness of a rule can be evaluated based on the structure of the rule itself. The statistical reasoning application focuses on the properties of the probability-based measures.

Generality evaluates the comprehensiveness of a pattern. A pattern is considered general if it covers relatively large number of cases in a given dataset. Both support and coverage are important indicators for the generality of a rule. The support of a rule r=X-->Y is the percentage of cases in “U” that contain both “X” and “Y”, and is denoted as: sup(r)=|(X∪Y)|/|U|=P(XY), where 0≦sup(r)≦1. |U| is the total number of cases under consideration dataset U and |(X∪Y)| denotes the number of cases covered by both “X” and “Y”. Support can be used as an indication of how often a rule “r” occurs in a data store and as a consequence how significant of a rule. The coverage of a rule “r” defines the fraction of cases covered by the antecedent of the rule and is denoted as: coverage(r)=|(X)|/|D|=P(X), where 0≦coverage(r)≦1. It is antecedent support, completeness, and sensitivity.

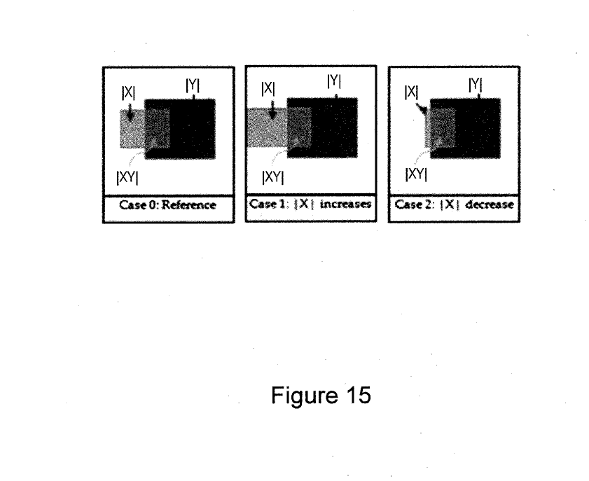

The support of a rule is dependent on the size of given data for a pre-defined support threshold. Normally, the larger the support value is, the more interesting the rule will be for a user. This threshold is programmed to a sufficiently high level for identifying reliable rules and reducing the traversal of search space. Rules with a low support value are designated as likely representing outliers or very small numbers of cases. In some applications, relatively infrequent associations may be of great interest as they relate to rare but crucial cases, such as identifying rare diseases in medical contexts (i.e., Ebola). In addition, when the dataset consists of a very uneven distribution of frequency for individual values, an association rule with a low support value might have a much greater impact than the ones with a high support value. Furthermore, the support of a rule is invariable to the change of the absolute support of “X”. FIG. 15 shows that in case 1 and 2, the rule X-->Y is more applicable when |X| decreases. Therefore, the statistical reasoning application applies criteria of coverage to establish the reliability of a rule. The coverage threshold is programmed to a reasonably high value to ensure the applicability of the rule. The value range of the coverage is from 0 to 1. A coverage value close to 1 is expected for an important rule. When the coverage is small, the rule is designated weak.

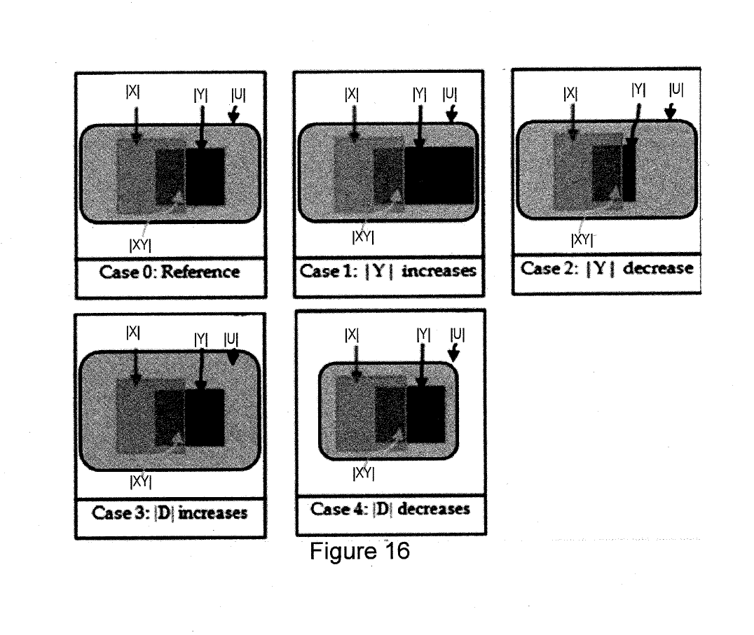

The reliability analytic evaluates the accuracy of the predication made by a rule. If the association described by a pattern occurs in a high fraction of applicable cases, it is designated reliable. Confidence and lift is used to define the reliability of a rule. The confidence for a rule r=X-->Y measures how often cases in “U” that contains “X” are labeled with class “Y” and is defined as: conf(r)=|(X∪Y)|/|(X)|=P(Y|X)=P(YX)/P(X), where 0≦conf(r)≦1. The problem with some confidence measures is that they do not take into account the baseline frequency of the consequent or the total number of transactions “U” as shown in FIG. 16. In fact, X-->Y is more likely to happen when the size of “Y” increases or when the size of “U” decreases. To overcome this issue, the lift of a rule “r” is defined as: lift(r)=|(X∪Y)|/[|(X)∥(Y)|]=P(Y|X)/P(Y)=P(YX)/[P(X)P(Y)])], where lift(r)≧0.

Rules with high confidence values are more predominant in the total number of cases. To detect spurious rules, the statistical reasoning application also adopts the criteria lift (a.k.a. interest). It measures how many times more often its antecedent and consequent occur together than expected, if they were statistically independent. A lift is a value about the increase in probability of the consequent given the antecedent part. A lift less than 1 means that there is a negative relationship between the antecedent and consequent; otherwise, there is a positive relationship. The lift ratio close to 1 implies that the antecedent and consequent are independent and indicates that the rule is not interesting. The larger the lift ratio, the more significant the rule is. The lift is not sensitive to rule direction, i.e., lift(X-->Y)=lift(Y-->X).

In the statistical reasoning application, a rule with high confidence, high support, high coverage, and high lift is preferred. For rules with the same confidence, the one with the highest support is preferred as they are more dependable. The confidence and coverage are not independent of each other. A rule with a higher coverage may have a lower confidence, while a rule with a higher confidence may have a lower coverage.

Some statistical reasoning applications apply the principle of minimum description length to construct the class association rules to represent the most general knowledge. If the class association rule r: x→y satisfies the thresholds for support Δ₁, coverage λ₂, confidence λ₃, and lift λ₄, the term x is not extended further to assure that the extracted rules are the shortest. In other words, the system generates the short class association rules. This makes the size of the result set manageable and the rules easier to interpret than traditional class association rules. The statistical reasoning comprises two main steps: (1) generate all frequent closed factor-sets, and (2) generate strong semantic associations.

To generate all frequent closed factor-sets, a breadth-first bottom-up approach is executed where frequent subsets are extended one factor at a time. In each pass, the system generates new candidates with the required support via a SPARQL command. For k=2, all candidates are closed frequent factor-sets. For k>2, the support of each candidate is tested against its subsets' support found in the previous pass. If candidates have the same support count, the candidate will be pruned from the closed frequent factor-set list. The total number of iterations needed by the algorithm is kmax+1, where kmax is the maximum size of frequent factor-sets.

The statistical reasoning algorithm can be expressed in SPARQL language. Referring to FIG. 14, “T” is the target predicate, there are 6 cases, and λ₁ and λ₂ are 15%. The minimum absolute support and coverage is 1. The following SPARQL statement generates a set of valid target factors. Two target factors are found. These factors and their support counts are {[(T,v1),4], [(T,v2),2]}.

SELECT ?pt ?ot (COUNT(*) AS ?Ycnt)
WHERE {?s ?pt ?ot.
FILTER (regex (str(?pt), ‘T’, ‘i’ )).}
GROUP BY ?pt ?ot
HAVING (?Ycnt >= 1)

Below SPARQL statement find three condition factors: {[(A,v3),4], [(A,v2,1], [(B,v3),5]}.

SELECT ?pc ?oc (COUNT(*) AS ?Xcnt)
WHERE {?s ?pc ?oc.
FILTER (!regex (str(?pc), ‘T’,‘i’)).}
GROUP BY ?pc ?oc
HAVING (?Xcnt > 1)

The above two query statements can construct all 1-factor-sets. Next, the frequent 2-factor-sets and their support are computed by using the following SPARQL statement. Five closed frequent 2-factor-sets {[(A,v2)(T,v1),1], [(A,v3)(T,v1),3], [(B,v3)(T,v1),3], [(A,v3) (T,v2),1], [(B,v3)(T,v2),2]} are found.

```
SELECT ?pc ?oc ?pt ?ot (count(*) AS ?supCNT)
WHERE { ?s ?pt ?ot .
      FILTER (regex (str(?pt), ‘T’,‘i’)).
      ?s ?pc ?oc .
      FILTER (!regex (str(?pc), ‘T’,‘i’)).}
GROUP BY ?pc ?oc ?pt ?ot
HAVING (?supCNT >=1)
ORDER BY ?pt ?ot
```

To construct frequent 3-factor-sets, the following SPARQL statement can be executed. It produces four frequent factor-sets {[(A,v2)(A,v3)(T,v1),1], [(A,v2)(B,v3)(T,v1),1], [(A,v3)(B,v3)(T,v1),2], [(A,v3)(B,v3)(T,v2),1]}. Only [(A,v3)(B,v3)(T,v1),2] is a closed frequent factor-set as it has a different support count than its subsets [(A,v3)(T,v1), 3] and (B,v3)(T,v1),3].

```
SELECT ?pc1 ?oc1 ?pc2 ?oc2 ?pt ?ot (count(*) AS ?supCNT)
WHERE { ?s ?pt ?ot .
      FILTER (regex (str(?pt), ‘T’,‘i’)).
      ?s ?pc1 ?oc1 .
      FILTER (!regex (str(?pc1), ‘T’,‘i’)).
      ?s ?pc2 ?oc2 .
FILTER (!regex (str(?pc2), ‘T’,‘i’)&& !regex (str(?pc2), str(?pc1),‘i’) ).}
GROUP BY ?pc1 ?c1 ?pc2 ?oc2 ?pt ?ot
HAVING (?supCNT >=1)
ORDER BY ?pt ?ot
```

To construct 4-factor-sets the SPARQL statement that follows can be used. It produces an empty set; therefore, this step is terminated.

```
SELECT ?pcl ?oc1 ?pc2 ?oc2 ?pc3 ?oc3 ?pt ?ot (count(*) AS ?supCNT)
WHERE { ?s ?pt ?ot .
      FILTER (regex (str(?pt), ‘T’,‘i’)).
      ?s ?pc1 ?oc1 .
      FILTER (!regex (str(?pc1), ‘T’,‘i’)).
      ?s ?pc2 ?oc2 .
FILTER (!regex (str(?pc2),‘T’,‘i’)&& !regex (str(?pc2), str(?pc1),‘i’)).
      ?s ?pc3 ?oc3 .
FILTER (!regex (str(?pc3), ‘T’, ‘i’)&& !regex (str(?pc3), str(?pc1)‘i’,) &&
!regex (str(?pc3),
str(?pc2), ‘i’)).
}
GROUP BY ?pc1 ?oc1 ?pc2 ?oc2 ?pc3 ?oc3?pt ?ot
HAVING (?supCNT >=1)
ORDER BY ?pt ?ot
```

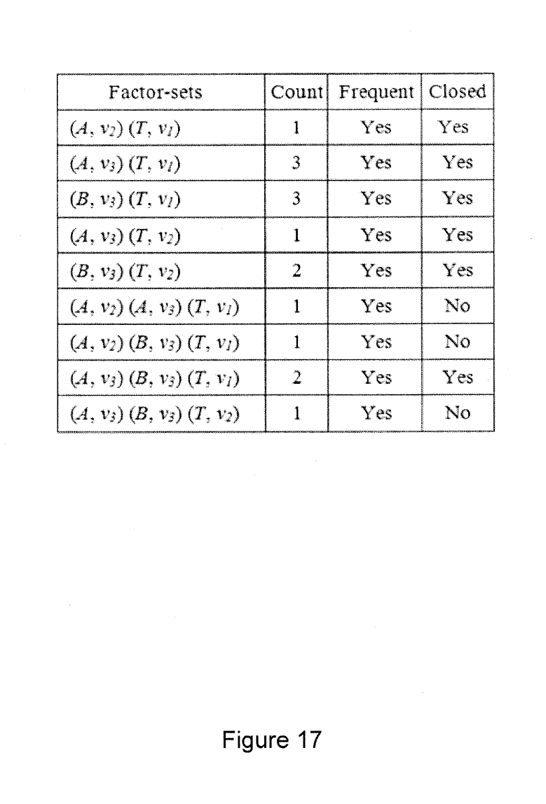

The statistical reasoning approach can effectively limit the search space for a concise set of frequent factor-sets. Such set of frequent patterns is sufficient to determine a reduced set of class association rule without information loss. In this example nine frequent factor-sets are found and six of them are closed frequent factor-sets as shown in FIG. 17.

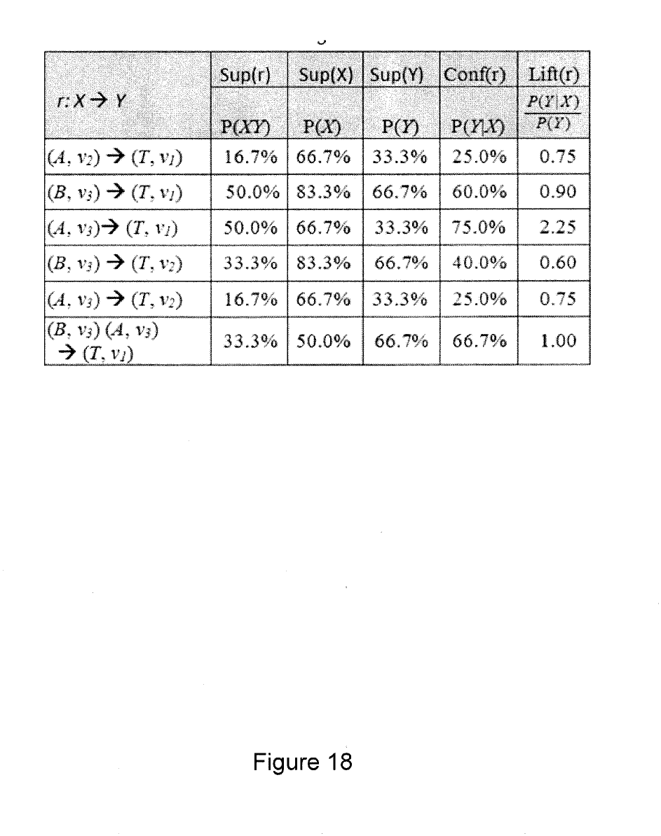

Once all closed frequent factor-sets have been identified, the statistical reasoning application turns each factor-set into a rule. To generate a rule, the length of a factor-set is two or more and the last element of each factor-set is the target factor. For any pattern length “k”, the left most (k−1)-factors and the last element are the antecedent and the consequent of a rule, respectively. Referring to the example shown in FIG. 14, one class association rule [(A,v3)(B,v3)]-->[(T,v1)] is constructed based on the 3-factor-set of [(A,v3)(B,v3)(T,v1)]. In that example, 6 closed frequent factor-sets were identified. The table in FIG. 18 shows these rules and their support, coverage, confidence, and lift.

The logical reasoning application also scales the big data of the semantic Web. Using both structural and semantic information to generate score paths, the logical reasoning application identifies implicit associations that are missed. The software processes structural and semantic information to generate and score paths between terms. The software filters the graph to only include terms likely to be specific and the field of interest. It forms paths based on structural heuristics that it scores semantically. To compute those scores, individual predicates and subject-types are assigned values based on an expert system or subject matter expert's evaluation of sample paths. The total path score is a weighted combination of these values. The software optimizes the weights to minimize Tau coefficient differences between sample scores and those of the expert system and subject matter expert. The Tau coefficient, as a length-normalized metric is defined as

$$τ = \frac{{n}_{c} - {n}_{d}}{\frac{1}{2} n ( n - 1 ) !}$$

where n_{c} is the number of concordant pairs and n_{d} is the number of discordant pairs, or inversions.

The logical reasoning application can process all subject matter domains, including medical based domains that are described below to illustrate aspects of the software's functionality. Since many medical domains contain many triples that contain no useful or novel information, it is first filtered as previously described. Alternatively, the medical domains are filtered based on a specific score. In this alternative, each triple receives a score based on its uniqueness: where the score=(1/sp-count)*(1/po-count) where sp-count is the number of times in the graph a given subject and predicate appeared together in a triple, and po-count is the number of times in the graph a given predicate object appeared together. This represents counts of individual edge types entering or leaving a particular node. A threshold is computed based on the average po-count and sp-count for each predicate: thresh=(1/sp-avg)*(1/po-avg). In this process, a triple is filtered out if its score is lower than the threshold, leaving only triples for which the number of times its predicate is associated with its subject and with its object is higher than a predetermined average.

The system then constructs paths by executing a user specified number of intermediate “hops”. Since the paths do not have cycles, one term can appear at most once in a path. The score of each triple is then averaged to find the total path score with only a pre-determined number retained, such as the top 100, for example.

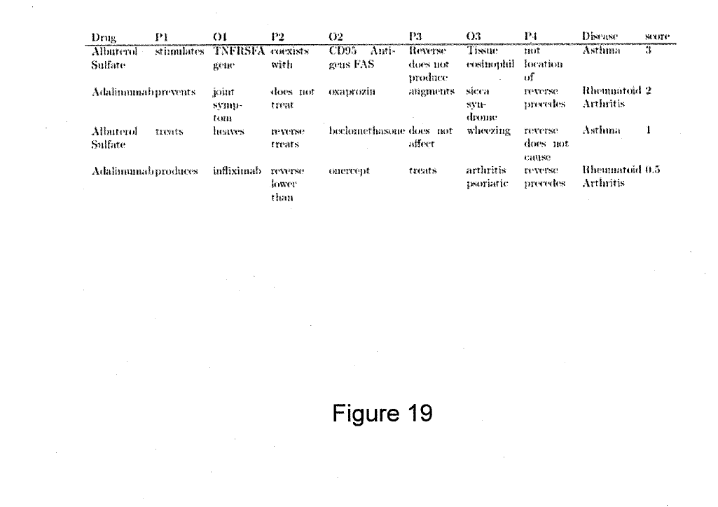

Expert systems or domain experts score the generated paths to establish validity. The subject matter expert, or expert system, may rate the paths as “relevant”, “potential”, “irrelevant” or “generic”. Such designations may denote the degree to which a path might explain the relationship between a start and an end term. “Relevant” paths may use specific terms as intermediates. Each connection is well supported by sources, such that a search for any two connections, there exist multiple objects or articles linking them in a causal not comparative way. “Potential” paths may have such support from few objects or articles, or the sources may only mention them, rather than providing a strong association. Some pairs of connections may not be supported by objects or literature. “Generic” paths are those that used terms that could be connected to anything. Literature may or may not have supported the associations between connections, and the paths could potentially create true statements, but even if they did so, they would never generate useful insights. Examples of each type of path may be evaluated in a drug research is shown in FIG. 19.

In applying a logical reasoning application to the filtered semantic data such as how a drug treats a disease, the system computes statistics showing how often each subject type was combined with each predicate and each object type on the full graph. To find the likelihood that a given type-predicate-type triple belonged to a path between two terms connected by a “treats” relationship, the system divides the frequency with which the terms appeared in the those paths by the frequency with which it appeared in the general graph. The system then scores the path by multiplying the probability that each link that was part of a treating path rather than a random occurrence. This process determines the likelihood of a treatment having a relationship between the start and the end term of a path. Because different types of predications may be encountered in different steps of a path the system recursively separated triples that occurred in each successive “hop” of the path and computes the probability for each type-predicate-type triple in each hop.

The methods, devices, systems, and logic described herein have been implemented in many different combinations of hardware, software and both hardware and software. All or parts of the system have been executed by controllers, one or multiple microprocessors (CPUs) that interfaces or includes a multithreaded hardware accelerator that supports multiple hardware (e.g., up to about 128 hardware threads or any number below) and software threads (e.g., up to 65 K threads or any number below in a 512 processor and more than a million with over 8 k processors). The large globally shared memory of this architecture can scale to large data and enable uniform low-latency access to some or all the data in the graphs. A graph in this disclosure is made up of vertices or nodes or points and edges or arcs (e.g., ordered pairs of vertices) or lines that connect them. A graph may be undirected, meaning that there is no distinction between the two vertices associated with each edge, or its edges may be directed from one vertex to another. The disclosures highly scalable I/O port receives and transmits data at high rates (e.g., up-to or below 350 TB/hr). The methods, devices, systems, and logic access a W3C compliant RDF quad store that can be accessed by SPARQL, providing a sophisticated pattern matching and dynamic data update capability that supports whole graph algorithms. The hardware is run in a blade configuration.

When executed by multi-core processors (e.g., one or more CPUs, SPUs, and/or GPUs), results may be displayed through a display driver in communication with a remote or local display, or stored in a tangible or non-transitory machine-readable or computer-readable medium such as flash memory, random access memory (RAM) or read only memory (ROM), erasable programmable read only memory (EPROM) or other machine-readable medium. Thus, a product, such as a computer program product, may include a storage medium and computer readable instructions stored on the medium, which when executed in an endpoint, computer system, or other device, cause the device to perform operations according to any of the description above.

The systems may evaluate data structures through processors, memory, interconnected shared and/or distributed among multiple system components, such as among multiple processors and memories, including multiple distributed processing systems. Parameters, databases, software and data structures used to evaluate and analyze these data sets may be separately stored and managed, may be incorporated into a single memory or database, may be logically and/or physically organized in many different ways, and may be implemented in data structures such as linked lists, programming libraries, or implicit storage mechanisms. The disclosed applications also known as application programs may be part (e.g., subroutines) of a single program, separate programs, application program or programs distributed across several memories and processor cores and/or processing nodes, or implemented in many different ways, such as in a library, such as a shared library. The library may store the described applications as software applications. While various embodiments have been described, it will be apparent to those of ordinary skill in the art that many more embodiments and implementations are possible.

The term “coupled” disclosed in this description encompasses both direct and indirect coupling. Thus, first and second parts are said to be coupled together when they directly contact one another, as well as when the first part couples to an intermediate part which couples either directly or via one or more additional intermediate parts to the second part. The term “substantially” or “about” may encompass a range that is largely, but not necessarily wholly, that which is specified. It encompasses all but a significant amount (e.g., more than ninety percent). The term “big data” disclosed in this description describes data sets so large or complex that traditional or conventional data processing applications and conventional computers cannot process the scale of data. Neither conventional computers nor paper and pencil (e.g., humans) can execute the processes and calculations described in this disclosure. The aspect of scale should not be overlooked in this disclosure. Without the ability to execute fast retrievals in a parallel processing super computing architecture, meta-pattern reasoning or path-based reasoning, for example, could not be executed as disclosed. The disclosed technology makes the retrievals and processing of massive knowledge graphs possible. As a corollary to the comprehensive computing hardware and processed described in this disclosure, the resulting algorithms and their output are scalable to lesser hardware—establishing a functionality that can scale and improve latency based on the processing of specialized-hardware (supercomputers) while also being flexible to provide the resulting algorithms and output that scales to less powerful hardware (data-centers). Any effort of a conventional computer or human will not produce the same result. When devices are responsive to or occur in response to commands, events, and/or requests, the actions and/or steps of the devices, such as the operations that devices are performing, necessarily occur as a direct or indirect result of the preceding commands, events, actions, and/or requests. In other words, the operations occur as a result of the preceding operations. A device that is responsive to another requires more than an action (i.e., the device's response to) merely follow another action.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A data infrastructure for holistic graph data mining process comprising:
normalizing big data by extracting data sets published, mined or represented following the Semantic Web standards and storing the normalized data in a software stack in an electronic memory optimized for generating and processing knowledge graphs;
generating a plurality of conditional probability distributions based on a entity- and type-triples;
automatically constructing a plurality of semantically meaningful paths (sequence of pairwise associations) as a sub-graph based on the plurality of conditional probabilities; and
rendering a plurality of paths that model pairwise relations between objects of the normalized data comprising a predetermined or a user-specified number of hops.

2. The process of claim 1 where the conditional probability is based on a type-triple of a form comprising a subject-type, an object-type, and a predicate.

3. The process of claim 2 where the conditional probability is based on the type-triple having the predicate and the object-type based on the subject-type.

4. The process of claim 3 where the normalizing act selects a triple-type based on a subject-type and subsequent type-triples are selected based on the conditional probability distributions.

5. The process of claim 4 where the subject-type comprises the prior type-triples object-type.

6. The process of claim 1 where the type-triple are analogous to a designated triple type and conditional probabilities are based on data not directly related to the normalized data.

7. The process of claim 1 where the conditional probabilities comprise calculating a score based on a reciprocal of each subject, predicate, object triple of the normalized data.

8. The process of claim 1 where the act of normalizing the data comprises extracting data sets based on a subject-predicate score and predicate object score of all of the mined data.

9. The process of claim 8 where the act of normalizing the data comprises comparing the product of the subject predicate score and the predicate object score of the mined data to the product of an average subject predicate score and an average predicate object score of the subjects and objects of a computational knowledge graph.

10. The process of claim 8 where the act of normalizing comprises comparing the subject-predicate score and the predicate object score to a calculated threshold.

11. The process of claim 1 where the probability distribution is based on a quotient of the frequency a predicate is detected in the normalized data to the frequency the predicate appears in the mined data.

12. A system that mines knowledge graphs across the Semantic Web comprising:
a scalable input/output interface that receives data from the Semantic Web at varying transmission rates;
a distributed memory coupled to the scalable input/output interface that scales to large data and enables access to computer data graphs without memory partitioning or memory access patterns;
a multithreaded processor coupled to the distributed memory that enables access to multiple random dynamic memory references without prefetching or caching, programmed to:
mine big data across the Semantic Web through the scalable input/output;
normalize the big data by extracting data sets mined from the Semantic Web and storing the normalized data in a software stack in the shared memory optimized for generating knowledge graphs;
generating a plurality of conditional probability distributions based on a type-triple;
automatically constructing a plurality of paths of a sub-graph based on the plurality of calculated conditional probabilities; and
rendering a plurality of paths that model pairwise relations between objects of the normalized data comprising a predetermined number of uniform hops.

13. The system of claim 12 where the conditional probability is based on a type-triple of a form comprising a subject-type, an object-type, and a predicate.

14. The system of claim 13 where the conditional probability is based on the type-triple having the predicate and the object-type based on the subject-type.

15. The system of claim 12 where the normalizing act selects a triple-type based on a subject-type and subsequent type-triples are selected based on the conditional probability distributions.

16. The system of claim 15 where the subject-type comprises the prior type-triples object-type.

17. The system of claim 12 where the type-triple are analogous to a designated triple type and conditional probabilities are based on data not directly related to the normalized data.

18. The system of claim 12 where the conditional probabilities comprise calculating a score based on a reciprocal of each subject, predicate, object triple of the normalized data.

19. The system of claim 12 where the act of normalizing the data comprises extracting data sets based on a subject-predicate score and predicate object score of all of the mined data.

20. The system of claim 12 where the act of normalizing the data comprises comparing the product of a subject predicate score and a predicate object score of the mined data to the product of an average subject predicate score and an average predicate object score of the subjects and objects of a computational knowledge graph.
